(19) United States
(12) Patent Application Publication
(10) Pub. No.: US 2020/0375340 A1
(43) Pub. Date: Dec. 3, 2020

(54) RUBBER STAMP FOR EYEBROW SHAPING, FILLING, AND ENHANCING EYEBROWS

(71) Applicant: Sondra Reames Owens, Memphis, TN (US)

(72) Inventor: Sondra Reames Owens, Memphis, TN (US)

(21) Appl. No.: 16/654,776

(22) Filed: Oct. 16, 2019

Related U.S. Application Data
(60) Provisional application No. 62/853,952, filed on May 29, 2019.

(51) Int. Cl. A45D 34/04; B41K 1/56

(52) U.S. Cl. CPC A45D 34/04; B41K 1/56

(57) ABSTRACT

A stamping tool for a human browbone includes a rubber stamp plate with an etching that is a replication of a typical human eyebrow. The etching includes a plurality of substantially vertical, substantially horizontal, and slanted etchings adapted to appear as eyebrow hairs. An elongated handle is attached to the rubber stamp plate at a distal end of the elongated handle. The stamping tool results in a natural looking eyebrow stamp even when examined up close.

### CROSS-REFERENCE TO RELATED APPLICATION

This application claims the benefit of priority of U.S. provisional application No. 62/853,952 filed on May 29, 2019, the contents of which are herein incorporated by reference.

### BACKGROUND OF THE INVENTION

The current invention is related to eyebrow shaping devices, and more particularly, to a rubber stamp in the shape of an eyebrow for shaping, filling, and enhancing eyebrows.

Many people naturally have very sparse eyebrows. Many individuals lose eyebrows and eyebrow hair density due to aging, medical conditions, or medical treatments. This often affects these individuals' confidence in facing the world. An eyebrow pencil depends on a steady hand, and therefore does not produce a consistent look. Further, it is time consuming. A sponge/foam stamp is available, but it produces an unnatural look as it results in a solid line.

There exists a need for a tool that produces a natural look for eyebrows, that is precise and in the shape of real hairs instead of a straight hard line or fat brows, and results in a soft and real looking brow close-up.

### BRIEF DESCRIPTION OF THE DRAWINGS

FIG. 1 shows one embodiment of a perspective view of an eyebrow stamp brush and ink stamp pad;

FIG. 2 shows a side view of the eyebrow stamp brush;

FIG. 3 shows a front view of the eyebrow stamp brush;

FIG. 4 shows one embodiment of the eyebrow stamp brush in use; and

FIG. 5 shows multiple embodiments of the eyebrow stamp brush.

### SUMMARY OF THE INVENTION

A stamping tool for a human browbone includes a rubber stamp plate with an etching that is a replication of a typical human eyebrow. The etching includes a plurality of substantially vertical and substantially horizontal etchings adapted to appear as eyebrow hairs. The stamping tool also includes an elongated handle with the rubber stamp plate being attached at a distal end of the elongated handle.

In one embodiment, the etching can be any eyebrow shape. In one embodiment, the stamping tool includes an ink pad within which to dip the rubber stamp plate.

In one embodiment, the handle is plastic. In one embodiment, the etching appears as the eyebrow hairs of a left eyebrow. In one embodiment, the etching appears as the eyebrow hairs of a right eyebrow.

In one embodiment, the rubber stamp plate is removeable from the elongated handle.

In one embodiment, an eyebrow stamping tool for a human browbone includes a rubber stamp plate including an etching that is a replication of an arch, a head, or a tail of a human eyebrow. The etching includes a plurality of substantially vertical and substantially horizontal etchings adapted to appear as eyebrow hairs.

In one embodiment, an eyebrow stamping kit for a human eyebrow comprises a plurality of interchangeable rubber stamp plates, where each rubber stamp plate includes an etching that is a replication of an arch, a head, a tail, or an entire human eyebrow. The etching includes a plurality of substantially vertical and substantially horizontal etchings adapted to appear as eyebrow hairs. The kit further includes an elongated handle configured to attach to any of the plurality of interchangeable rubber stamp plates.

### DETAILED DESCRIPTION OF THE INVENTION

The following detailed description is of the best currently contemplated modes of carrying out exemplary embodiments of the invention. The description is not to be taken in a limiting sense but is made merely for illustrating the general principles of the invention, since the scope of the invention is best defined by the appended claims.

As stated above, many people struggle with sparse eyebrows due to multiple causes. The invention claimed here solves this problem.

Broadly, one embodiment of the present invention is a rubber stamp in the shape of an eyebrow with shaped hairs, which are easily stamped on the brow bone.

The claimed invention differs from what currently exists. The claimed tool is an arched eyebrow rubber stamp, in the shape of hairs. Unlike other devices, it quickly produces a very natural look utilizing an ink pad, because the stamp is precise and in the shape of real hairs. Rather than a straight hard line or fat brows, the result is soft and natural looking even when closely examined.

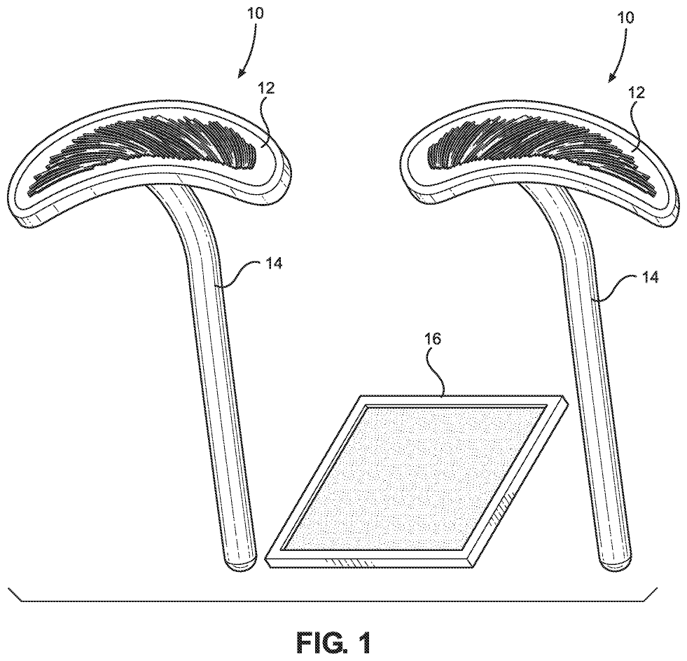

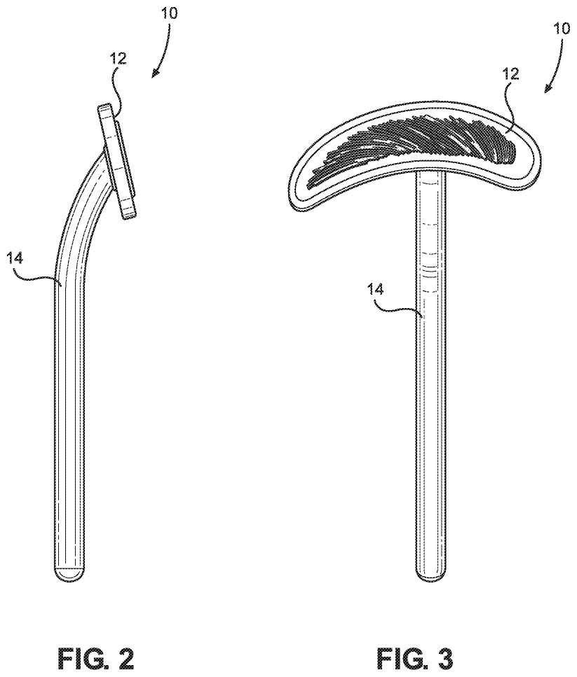

As shown in a perspective view of one embodiment of the present invention in FIG. 1, the claimed device includes an eyebrow stamp brush 10 with a rubber pad 12. The rubber pad 12 includes a plurality of etchings in the shape of typical human eyebrow hairs. The rubber pad 12 includes an elongated handle 14. The elongated handle 14 is about the length of a typical razor. The invention also includes an ink pad 16 on which to stamp the rubber pad 12 and create the eyebrow shape. A side view of the eyebrow brush 10 is shown in FIG. 2 and a front view of the eyebrow brush 10 is shown in FIG. 3. The ink is waterproof and can be removed with makeup remover.

In one embodiment, the invention includes eyebrow stamp brush 10 shaped for a left brow and a second eyebrow stamp brush 10 for a right brow.

In one embodiment, the etchings include a plurality of substantially horizontal and substantially vertical etchings to appear as natural eyebrows. The etchings are also a combination of hairs in various directions, for example, many slanted hairs, to provide the look of a natural brow.

In one embodiment, the rubber stamp plate is attached to a distal end of the handle 14. When rubber stamp 12 with an etching of the eyebrow is attached to the end of the handle 14, it is placed on an inked stamp pad to absorb ink. The eyebrow rubber stamp 12 is then placed on the brow bone where the brow is located.

In one embodiment, in order to make the invention, a mold is utilized to make an approximately 4-inch plastic handle with an approximately 2-inch flat end (like a disposable razor). The shape of an eyebrow is etched into the rubber plate, which is glued or attached by any suitable mechanism to the flat end of the handle 14. The small inked stamp pad is included and is available in three color choices: black, dark brown, or light brown. In alternative embodiments, the handle and flat end can be any suitable size and of any suitable material, for example, a metal material for a longer lasting quality.

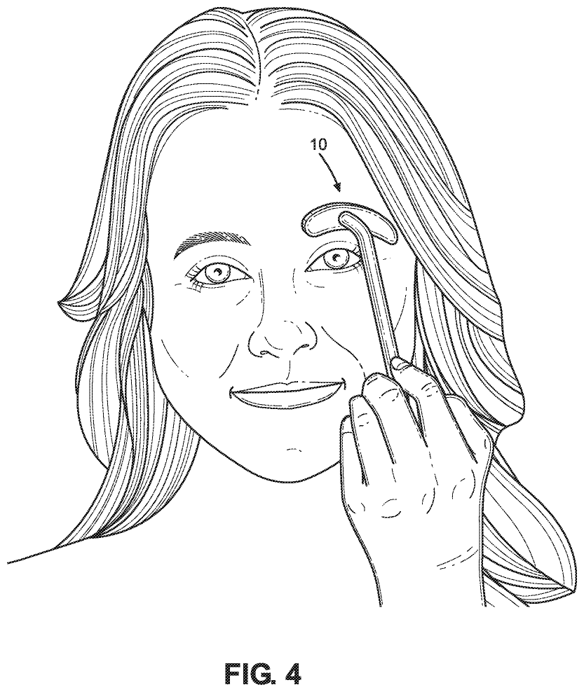

In one embodiment of use as shown in FIG. 4, the user holds the handle of the eyebrow stamp 10, presses the flat end (the rubber plate with etching) on the ink pad 16, aligns the eyebrow stamp brush 12 with the brow bone, and presses to apply.

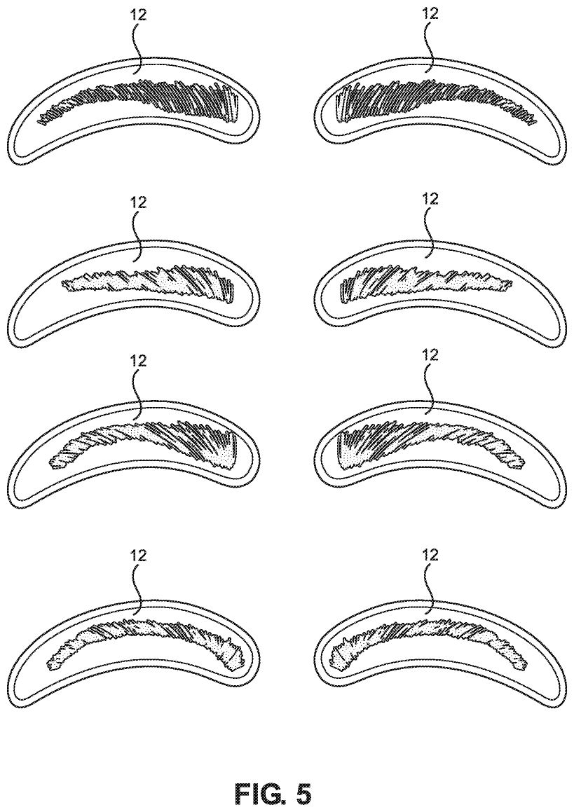

In one embodiment as shown in FIG. 5, the etching on the eyebrow stamp brush 12 is available in a variety of eyebrow shapes. Advantageously, a user may choose what is most suitable to the user's face.

In one embodiment (not shown), an eyebrow design element is divided into parts, so that a person can buy whatever part needed to enhance the brow. For example, one may purchase a stamp catering to the fullest part of the brow (the head), the arch, or the tail. The application of the device is the same for the embodiment of separate pieces as the previously described eyebrow stamp brush 10.

In one embodiment, the invention is a kit comprising various rubber plates 12 with different etchings. The etchings may include but are not limited to the parts of the brow, and/or one or more complete eyebrow shapes. The rubber plates 12 are interchangeable on a handle that allows attachment of any of the rubber plates. In another embodiment, each rubber plate 12 has its own handle 14.

In an alternative embodiment (not shown), a similar device is used to enhance lower eyelashes. The eyelash stamp is designed with very short etchings of lashes on the flat end, which can be inked and pressed on a lower lash line, close to the rim of the eye. When applied, it gives the appearance of a fuller lower lash.

It should be understood, of course, that the foregoing relates to exemplary embodiments of the invention and that modifications may be made without departing from the spirit and scope of the invention as set forth in the following claims.

What is claimed is:

1. A stamping tool for a human browbone comprising:
a rubber stamp plate comprising an etching that is a replication of a typical human eyebrow, the etching comprising a plurality of substantially vertical and substantially horizontal etchings adapted to appear as eyebrow hairs; and
an elongated handle, the rubber stamp plate being attached at a distal end of the elongated handle.

2. The stamping tool of claim 1, wherein the etching can be any eyebrow shape.

3. The stamping tool of claim 1, further comprising an ink pad within which to dip the rubber stamp plate.

4. The stamping tool of claim 1, wherein the handle is plastic.

5. The stamping tool of claim 1, wherein the etching appears as the eyebrow hairs of a left eyebrow.

6. The stamping tool of claim 1, wherein the etching appears as the eyebrow hairs of a right eyebrow.

7. The stamping tool of claim 1, wherein the rubber stamp plate is removeable from the elongated handle.

8. An eyebrow stamping tool for a human browbone comprising:
a rubber stamp plate comprising an etching that is a replication of an arch, a head, or a tail of a human eyebrow, the etching comprising a plurality of vertical and horizontal etchings adapted to appear as eyebrow hairs; and
an elongated handle, the rubber stamp plate being attached at a distal end of the elongated handle.

9. An eyebrow stamping kit for a human eyebrow comprising:
a plurality of interchangeable rubber stamp plates, each rubber stamp plate comprising an etching that is a replication of an arch, a head, a tail, or an entire human eyebrow, the etching comprising a plurality of substantially vertical and substantially horizontal etchings adapted to appear as eyebrow hairs; and
an elongated handle configured to attach to any of the plurality of interchangeable rubber stamp plates.
